(19) United States
(12) Patent Application Publication
(10) Pub. No.: US 2008/0195953 A1
(43) Pub. Date: Aug. 14, 2008

(54) Messaging Systems And Methods

(76) Inventor: Bibartan Sen, Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/912,893

(22) PCT Filed: May 2, 2005
(86) PCT No.: PCT/IN05/00133

§ 371 Date: Oct. 29, 2007

(51) Int. Cl. G06F 3/048; G06F 15/16; G06F 17/30

(52) U.S. Cl. 715/744; 709/202; 707/100; 707/E17.032

(57) ABSTRACT

Described is a method of sending a plurality of message components to a plurality of recipients via an electronic communication network, including the steps of: a) creating a first list of one or more recipient addresses; b) creating a second list including one or more of the recipient addresses; c) associating a first message component with the first list; d) associating a second message component with the second list; e) computer generating a single message for each recipient address including each message component associated with a list of which that recipient address is a member; and f) sending each generated message to its recipient address.

### FIELD OF THE INVENTION

The invention relates to email and other messaging systems and methods.

### BACKGROUND OF THE INVENTION

Email is used extensively throughout the world. In existing email systems, a message is created and is sent to a recipient or group of recipients specified by the sender.

Recipients can be added using single email addresses or email group aliases in the “To:” or “cc:” fields of the email client. The identities of some recipients can be concealed from other recipients by using the “bcc:” field.

However, in order to send a main message to a set of recipients and a “targeted” message to a subset of the set of recipients, it has been necessary to send the main message in a first email and to compose a second “targeted” message in a second email. Alternatively, the main message is forwarded or attached to an email to the subset of recipients, and the targeted message is added to the body of that email.

All these solutions involve writing multiple emails. The number of required emails may be large depending on the required combinations of targeted messages and the number of sets of recipients. These solutions are therefore inconvenient and inefficient, requiring the sender to spend significant amounts of time writing many emails. It can also be difficult to keep track of the various emails and combinations required.

While all the required information may be sent to an intended recipient, the various different messages required result in a collection of information which has lost the structure intended by the sender. This can make reading and interpreting the information difficult.

It is an object of the invention to provide an improved messaging method.

It is a further object of the invention to allow a sender to send a number of messages, each to a set of recipients, with a single “send” command.

It is a further object of the invention to allow a sender to compose a number of messages, each to a set of recipients, in a single window.

It is a further object of the invention to provide a messaging system allowing users to compose and send messages to various sets of recipients, more easily than allowed by existing email systems.

It is a further object of the invention to provide an improved method for displaying related email messages.

### SUMMARY OF THE INVENTION

In a first aspect the invention provides a method of sending a plurality of message components to a plurality of recipients via an electronic communication network, including the steps of:
a) creating a first list of one or more recipient addresses;
b) creating a second list including one or more of the recipient addresses;
c) associating a first message component with the first list;
d) associating a second message component with the second list;
e) computer generating a single message for each recipient address including each message component associated with a list of which that recipient address is a member; and
f) sending each generated message to its recipient address.

Preferably at least one recipient address is a member of only one of the first and second lists. Preferably the second list is a subset of the first list. Preferably all generated messages are sent in response to a single send command.

Preferably the method also includes displaying a first defined display region for display and entry of the first message component and displaying a second defined display region for display and entry of the second message component. Preferably the defined display regions are separate panes within a single window.

Preferably the method includes displaying a first address field for display and entry of recipient addresses, the first address field being associated with the first defined display region; and displaying a second address field for display and entry of recipient addresses, the second address field being associated with the second defined display region. The first list may be formed of recipient addresses which are entered in the first address field and the second list may be formed of recipient addresses which are entered in the second address field. Alternatively, the first list may be formed of recipient addresses which are entered in either of the first and second address fields and the second list may be formed of recipient addresses which are entered in the second address field.

Preferably the method includes displaying a first defined display region for display and entry of the first message component;
displaying a GUI object; and
in response to selection of the GUI object, opening and displaying a second defined display region for display and entry of the second message component.

Preferably step e) includes generating a message including the first and second message components and one or more tags defining the second message component.

This aspect also extends to a method of sending and receiving a message comprising sending a message as described above and receiving a message, including the steps of:
g) receiving a first generated message at one of the recipient addresses, the first generated message including the first message component and the second message component;
h) identifying the second message component;
i) displaying the first message component in a first defined display region; and
j) displaying the second message component in a second defined display region.

Preferably the method includes displaying a first “reply” GUI object associated with the first defined display region and a second “reply” GUI object associated with the second defined display region.

In a second aspect, the invention provides a message composing apparatus comprising:
a user interface for entering message components, entering or selecting recipient addresses and associating message components and recipient addresses;
memory for storing message components, recipient addresses and their associations;
a processor for generating a single message to be sent to each recipient including each message component associated with that recipient's address.

In a third aspect the invention provides a message displaying apparatus comprising:
a processor for receiving electronic messages including multiple message components and identifying the respective message components; and
a display system for displaying the respective message components in separate defined display regions.

In a fourth aspect the invention provides a messaging system comprising:
an electronic communication network;
sender user equipment connected to the electronic communication network, comprising:
   a user interface for entering message components, entering or selecting recipient addresses and associating message components and recipient addresses;
   memory for storing message components, recipient addresses and their association;
   a sender processor for generating a single message for each recipient including each message component associated with that recipient's address, and sending each message to its recipient;
recipient user equipment connected to the communication network, comprising:
   a recipient processor for receiving electronic messages including multiple message components and identifying the respective message components; and
   a recipient display system for displaying the respective message components in separate defined recipient display regions.

In a fifth aspect the invention provides an email message including a first message component for receipt by each member of a first list of recipients and a second message component for receipt by each member of a second list of recipients.

### BRIEF DESCRIPTION OF THE DRAWINGS

Embodiments of the invention will now be described, by way of example only, with reference to the accompanying drawings in which:

FIG. 1 shows a sender's email window with one main message pane and two targeted message panes;

FIG. 2 shows a recipient's email window with one main message pane and two targeted message panes;

FIG. 3 shows a recipient's email window with one main message pane and one targeted message pane;

FIG. 4 shows a recipient's email window with one main message pane;

FIG. 5 shows a recipient's email window, where the recipient's email client is not configured to recognise targeted messages; and

FIG. 6 is a schematic drawing of a communication network.

### DESCRIPTION OF THE INVENTION

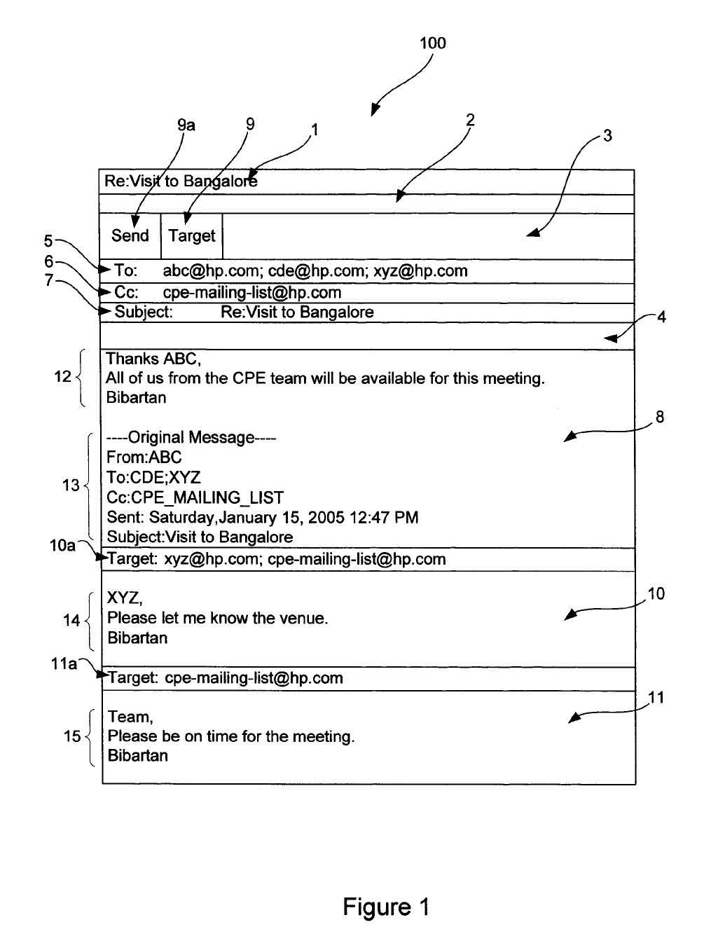

FIG. 1 shows a sender's email window. The window includes a title bar 1, menu bar 2, and tool bars 3 and 4. The usual “To:” 5, “Cc:” 6 and “Subject:” 7 fields are also provided (bcc is also available but is not shown). A user composes a first message component in the main message pane 8. The first message component will be sent to a first set of recipients specified by the email addresses, email nicknames and email group aliases listed in the “To:” and “Cc:” fields 5, 6 (and the Bcc field not shown). Other recipients may also receive the first message component, as explained below.

If the user wishes to send a second (or “targeted”) message component to a second set of recipients different to the first set, the user clicks the “Target” button (GUI object) 9 provided on the tool bar 3. Each time the “Target” button is clicked, a targeted message pane 10, 11 is added to the email window. Other methods of opening a targeted message pane, including selection of various GUI objects, may be suitable.

The user composes a targeted message component in each targeted message pane. The message component in a targeted message pane is sent to a target set of recipients specified by the email addresses, email nicknames and email group aliases entered in the “Target:” field 10a, 11a corresponding to that targeted message pane.

If an address is included in a Target field but not in any of the To, Cc or Bcc fields, the recipient specified by that address may be automatically added to the list of recipients for the first message component and treated as if their address was included in the Bcc field (or possibly the To or Cc field). The recipient's address may or may not be automatically added to and displayed in the Bcc (or To, or Cc) field. Therefore the set of recipients for the first message component may be taken directly from the To, Cc and Bcc fields, or may be taken from the To, Cc, Bcc and Target fields.

In an alternative embodiment, a message is sent only to a recipient if that recipient's address is included in the To, Cc and Bcc fields. A recipient whose address is not included in these fields, but is included in a Target field will not receive any message, so will not receive the targeted message component. In this embodiment a warning message may be displayed to indicate that an address is included in a Target field but not in any of the To, Cc or Bcc fields.

The first message component and the targeted message components are sent by clicking the “Send” button 9a provided on the tool bar 3. Other “send” commands may be suitable, but preferably the first message component and the targeted message components are all sent in response to a single “send” command. The term “send command” means a command that causes the message to be sent or added to a send queue. For example, the send command may transfer a message to an Outbox, to be sent when the user connects to the appropriate communication network.

When a send command is given, the sender's email client forms separate email messages from the message panes 8, 10, 11. The first email consists of the first message component only. This email is sent to each email address mentioned in the To, CC and BCC fields, but not included in any Target field 10a, 11a. In the example, this email is sent only to ABC and CDE.

The second email consists of the first message component and the first targeted message component 14.

If the first message component includes a reply part 12 and an “original message” part 13, the email consists of the reply part 12 followed by the first targeted message component 14 and finally the content of the “original message” part 13, in that order. The reason for using this order is discussed below.

The first targeted message component will be enclosed in between separating tags. For example, this part of the message might be in the following format:

///////// FOLLOWING IS A TARGETED MESSAGE BEGIN////////////
<<targeted_message_begin>>

<<target_msg_begin>>

<<target_begin>>

email addresses from the second target address fields of the second writing
pane

<<target_end>>

<<message_begin>>

Message contents from the second targeted message pane

<<message_end>>
<<target_msg_end>>

<<targeted_message_end>>
///////// FOLLOWING IS A TARGETED MESSAGE END////////////

There will be one target_msg_begin tag and one target_msg_end tag for each targeted message component included in the message. It will be appreciated that the tags may be in any format and may subscribe to a standardised xml format. Other methods of indicating the positions of the various message components may also be suitable. For example, a header or the like could be provided, with an indication of the start and end positions of a message component.

This second email is sent to the recipients included in the target field corresponding to the first targeted message pane, but not in any target field corresponding to a following targeted message pane. So, in this example the second email is sent to xyz@hp.com but not the cpe-mailing-list@hp.com group, which is also present in the target field corresponding to the second targeted message pane.

The third email consists of the first message component, the first targeted message component and the second targeted message component. In the example, the first message component includes a reply part and an “original message part”, so the third email includes the reply part 12 followed by the first and second targeted message components 14, 15, and the “original message” part 13 of the first message component, in that order. The targeted message components will be enclosed in between implementation dependent tags as mentioned above.

This third email is sent to recipients included in the target field of the second targeted message pane.

It will be appreciated that various permutations are possible. For example, the Target field for the first message pane could include only a single recipient, the Target field for the second message pane including a different, single recipient. In general, emails are created each including the first message component, or the first message component and targeted message components that have at least one recipient in common. Each email is then sent to the appropriate set of recipients.

If the receiving email client is aware of this technology then it interprets the tags to identify the message components and displays a number of panes accordingly. When sending a “reply all” message, that mail client automatically opens multiple target writing panes depending on the number of different target_msg_begin/end tags.

In the example shown in FIGS. 1 to 4, the recipients who are members of the “cpe-mailing-list” email group will receive the first message component and both targeted message components, as the email address cpe-mailing-list@hp.com is included in the “To:” field 5 and each of the “Target:” fields 10a and 11a.

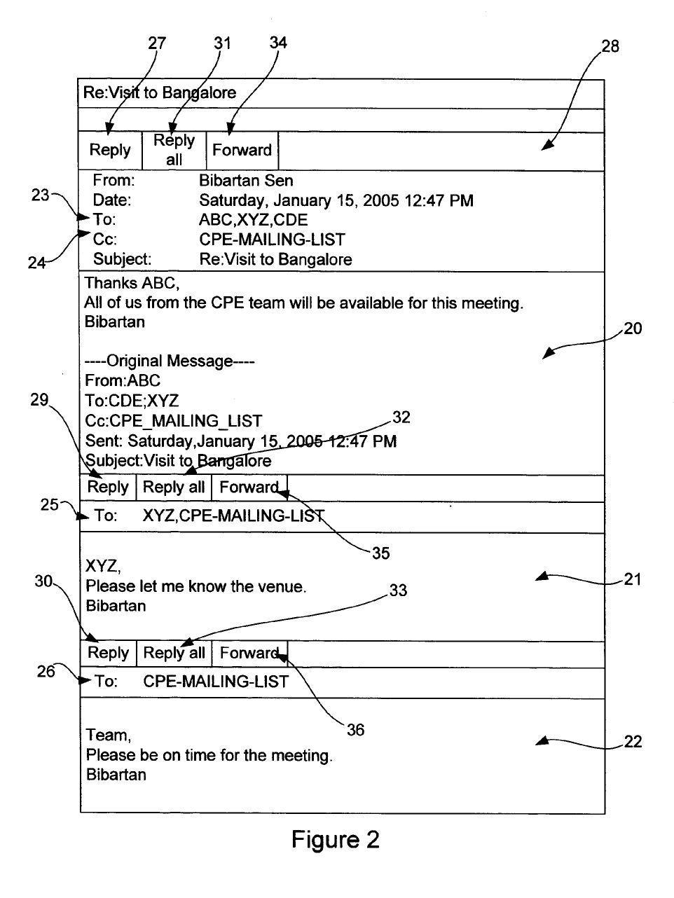

FIG. 2 shows the email message as received and displayed by a member of the “cpe-mailing-list” email group. The email window includes a main message pane 20 and two targeted message panes 21 and 22. The recipients of each part of the email are listed above the appropriate panes in the “To:” and “Cc:” fields 23, 24, 25, 26 so the recipient knows which message components have been received by the various recipients.

A recipient can reply to a message by clicking the “Reply” button 27 provided on the tool bar 28. Alternatively, the recipient can reply to a targeted message component by clicking on the “Reply” button 29, 30 corresponding to that targeted message component 21, 22.

Similarly a recipient can reply to all recipients of the main message by clicking on the “Reply all” button 31 provided on the tool bar 28. When this button is clicked, a window is created including a main message pane and targeted message panes, each having an “original message” part. Again, each targeted message component will be sent only to recipients listed in the corresponding Target field, as this is not intended for all recipients of the main message. A recipient can reply to all recipients of a targeted message component by clicking on the “Reply all” button 32, 33 corresponding to that targeted message pane 21, 22.

Messages can be forwarded in similar fashion using the forward buttons 34, 35, 36.

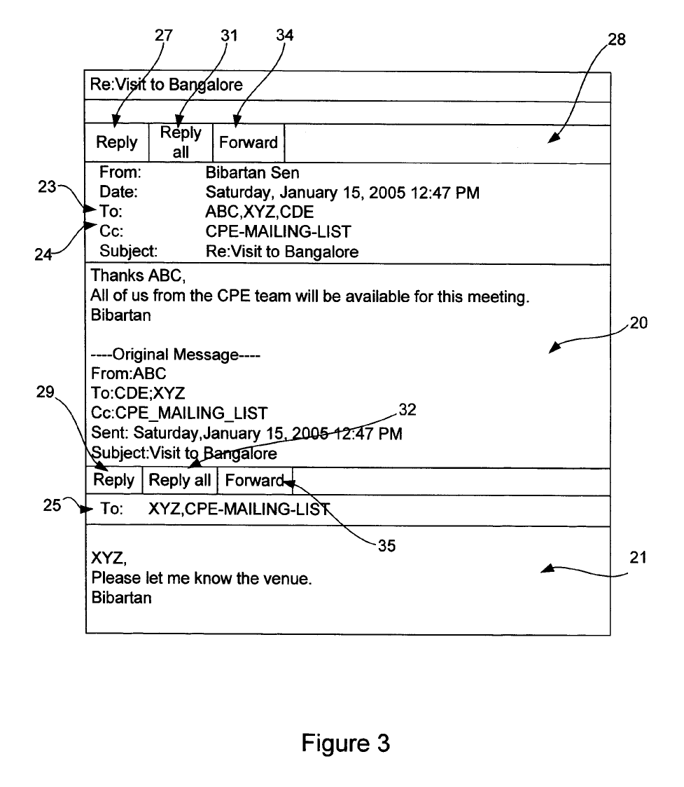

Returning to FIG. 1, the recipient XYZ will receive the main message and the first targeted message component, as the email address xyz@hp.com is included in the “To:” field 5 and the “Target:” field 10a. FIG. 3 shows XYZ's email window displaying the received message. The window includes a main message pane 20 and targeted message pane 21, but is otherwise similar to FIG. 2.

Returning again to FIG. 1, the recipient ABC will receive only the main message, as the address abc@hp.com is included in the “To:” field 5, but not in either “Target:” field 10a, 11a.

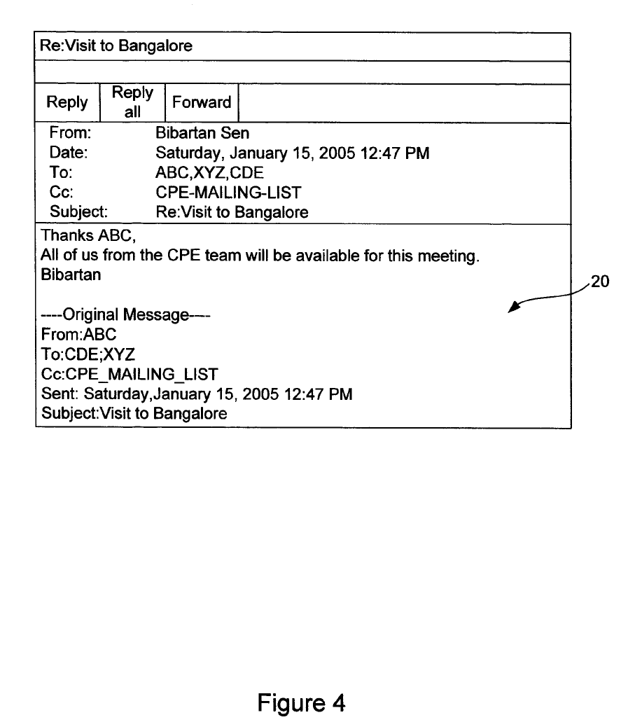

FIG. 4 shows ABC's email window displaying the received message. The window has a main message pane 20 and no targeted message pane.

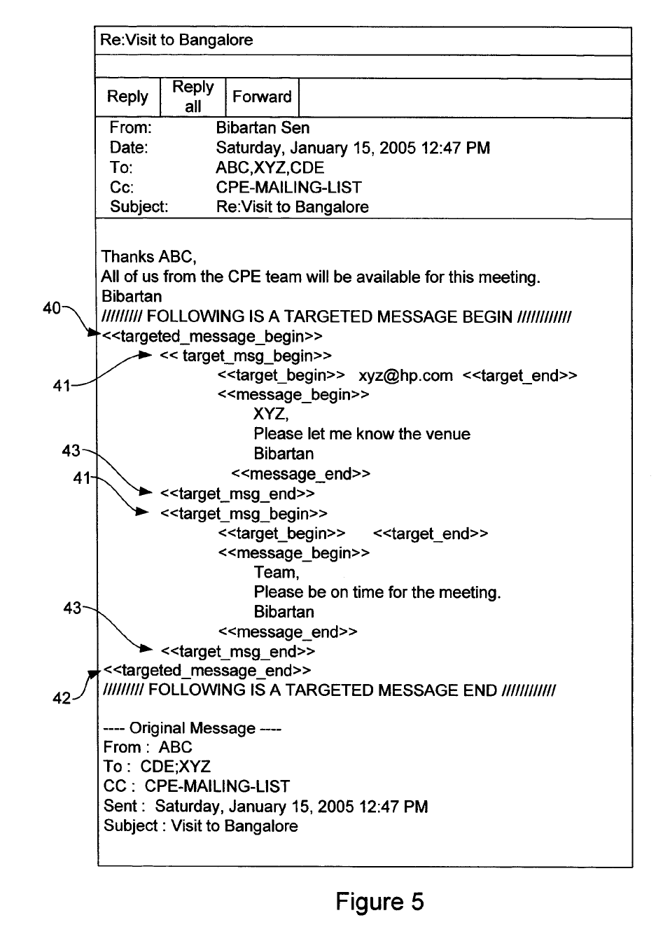

FIG. 5 shows the email message as displayed by a member of the “cpe-mailing-list” email group, where the recipient's email client is not configured to recognise the targeted message component tags and open separate panes accordingly. The message displays the tags as text. The tags include a first tag 40 indicating the start of all targeted message components, a second tag 41 indicating the start of a particular targeted message component, and corresponding tags 42, 43 indicating the end of all targeted message components and the end of a particular targeted message component.

Further notifications, such as “This text is intended only for you”, may also be inserted to remind the recipient that the targeted message component should be removed from a message to be sent to someone who is not an intended recipient of that targeted message component.

In FIG. 5, the reason for including the targeted message components before the “original message” part (if any) of the first message component is apparent. Where the client is not configured to recognise the tags, this “original message” part is displayed at the end of the email message. If the first message component were not split in this way, the “original message” part would be included immediately following the reply part. A recipient could easily overlook the targeted message components displayed below the “original message” text. Where a recipient's email client is configured to recognise the targeted message components, the “original message” part is also easily recognised and can be displayed in the main message pane.

As the message shown in FIG. 5 is received by a member of the “cpe-mailing-list” email group, the cpe-mailing-list address has been removed from the Target field by the sender's email client. This address could be left in the Target field in some applications. For example, if a complete list of recipients is to be maintained with the email message for forwarding and reply purposes, it may be more convenient to leave the recipient's address in the appropriate field.

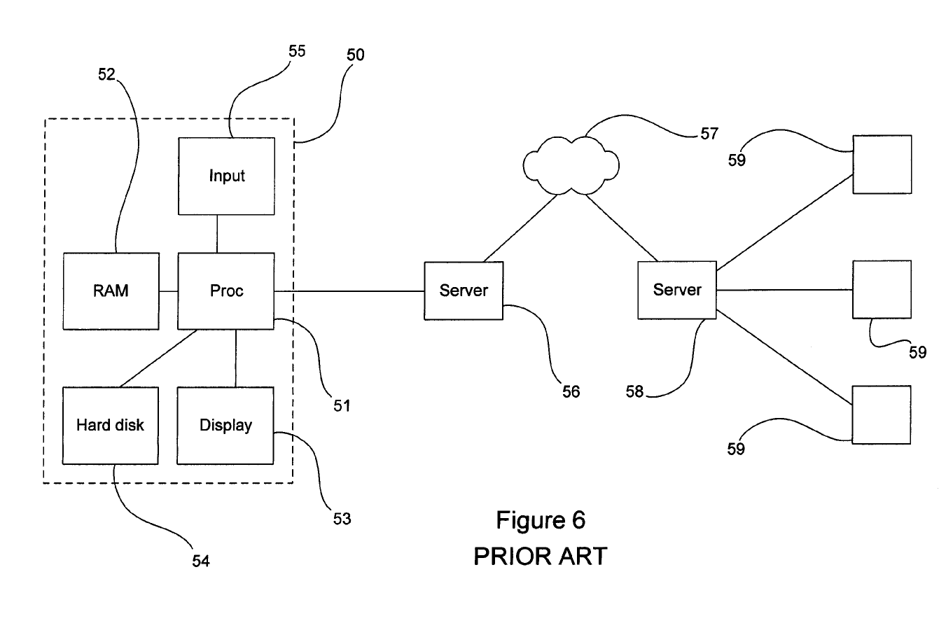

FIG. 6 is a schematic diagram of a communications system in which the invention may be implemented. The system includes a first user system 50, having a processor 51, RAM 52, a display device 53, hard disk 54 and a user input device 55. An email client runs on the first user system, in a manner well understood by those skilled in the art.

The user system 50 is connected to a server 56 by a wired (e.g. Ethernet) or wireless (e.g. wifi) connection. Server 56 is connected via a communications network 57 (such as the Internet) to a second server 58, itself connected to a plurality of user systems 59, each of which is similar to the first user system 50.

The invention may be implemented by email clients running on the user systems 50, 59. Alternatively, a separate module may be provided, running on one or more of servers 56, 58, or the invention may be implemented by the user systems 50, 59 and servers 56, 58 together.

In an alternative method, all message components could be sent to all recipients included in any of the To, Cc, Bcc and Target fields. The recipient's email client could be configured to display only those message components intended for the recipient. This has the disadvantage that a secure system with suitable encryption would be required. If a secure system were not provided, content not intended for the recipient could possibly be extracted by the recipient. However, this method has the advantage that a record of the entire email exchange could be maintained in a single email.

In another alternative method all message components could be sent to a server, which analyses the various fields and message components and compiles the various emails. In this case the server is performing a function performed by the sender's email client in the example described above. This has the disadvantage that the load on the server is increased. However, the server could keep a record of related message components, so that a record of an entire email exchange could again be sent to each recipient, in a single email. This system may be suitable in internal messaging systems, for example.

While the invention has been described with reference to an example in which each list of recipients for a “targeted” message component is a subset of a list of recipients for a first message component, this need not always be the case. For example, the two lists could overlap. That is, one list could include recipients A, B and C, while the other list includes recipients A, D and E. In this case both message components would be sent only to recipient A, each of the remaining recipients receiving only one message component.

While the invention has been described with reference to an example in which message components are displayed in separate panes in a single window, the components may also be displayed in separate defined display regions other than panes in a window. For example, message components may be displayed in a tabbed environment. The term “defined display region” means a display region defined by a border separating text in that region from text in another region.

While the invention has been described above in relation to an email system in which email clients are provided on each user's computer, the invention could be implemented in other email systems, such as internet mail (e.g. Hotmail).

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of sending a plurality of message components to a plurality of recipients via an electronic communication network, including the steps of:
a) creating a first list of one or more recipient addresses;
b) creating a second list including one or more of the recipient addresses;
c) associating a first message component with the first list;
d) associating a second message component with the second list;
e) computer generating a single message for each recipient address including each message component associated with a list of which that recipient address is a member; and
f) sending each generated message to its recipient address.

2. A method as claimed in claim 1, wherein at least one recipient address is a member of only one of the first and second lists.

3. A method as claimed in claim 1, wherein the second list is a subset of the first list.

4. A method as claimed in claim 1, wherein all generated messages are sent in response to a single send command.

5. A method as claimed in claim 1, including displaying a first defined display region for display and entry of the first message component and displaying a second defined display region for display and entry of the second message component.

6. A method as claimed in claim 5, wherein each defined display region is a separate pane within a single window.

7. A method as claimed in claim 5, including:
displaying a first address field for display and entry of recipient addresses, the first address field being associated with the first defined display region; and
displaying a second address field for display and entry of recipient addresses, the second address field being associated with the second defined display region.

8. A method as claimed in claim 7, wherein the first list is formed of recipient addresses which are entered in the first address field and the second list is formed of recipient addresses which are entered in the second address field.

9. A method as claimed in claim 7, wherein the first list is formed of recipient addresses which are entered in either of the first and second address fields and the second list is formed of recipient addresses which are entered in the second address field.

10. A method as claimed in claim 1, including:
displaying a first defined display region for display and entry of the first message component;
displaying a GUI object; and
in response to selection of the GUI object, opening and displaying a second defined display region for display and entry of the second message component.

11. A method as claimed in claim 1, wherein step e) includes generating a message including the first and second message components and one or more tags defining the second message component.

12. A method of sending and receiving a message comprising sending a message according to the method of claim 1 and receiving a message, including the steps of:
g) receiving a first generated message at one of the recipient addresses, the first generated message including the first message component and the second message component;
h) identifying the second message component;
i) displaying the first message component in a first defined display region; and
j) displaying the second message component in a second defined display region.

13. A method as claimed in claim 12, wherein each defined display region is a separate pane within a single window.

14. A method as claimed in claim 12, including displaying a first “reply” GUI object associated with the first defined display region and a second “reply” GUI object associated with the second defined display region.

15. A message composing apparatus comprising:
a user interface for entering message components, entering or selecting recipient addresses and associating message components and recipient addresses;
memory for storing message components, recipient addresses and their associations;
a processor for generating a single message to be sent to each recipient including each message component associated with that recipient's address.

16. A message composing apparatus as claimed in claim 15, wherein the user interface includes a display system for displaying each message component in a separate defined display region.

17. A message composing apparatus as claimed in claim 16, wherein each separate defined display region is a separate pane within a single window.

18. A message composing apparatus as claimed in claim 16, wherein the display system is adapted to display a separate address field for display and entry of recipient addresses for each separate defined display region.

19. A message composing apparatus as claimed in claim 15, wherein the processor is adapted to insert one or more tags when generating a message, the tag(s) defining a message component.

20. A message composing apparatus as claimed in claim 15, wherein the processor is adapted to send messages to a plurality of recipients in response to a single send command, at least one of the messages including a plurality of message components.

21. A message displaying apparatus comprising:
a processor for receiving electronic messages including multiple message components and identifying the respective message components; and
a display system for displaying the respective message components in separate defined display regions.

22. A message displaying apparatus as claimed in claim 21, wherein each separate defined display region is a separate pane within a single window.

23. A message displaying apparatus as claimed in claim 21, the processor being adapted to identify one or more tags within a received electronic message, the tags defining one or more message components.

24. A message displaying apparatus as claimed in claim 21, the display system being adapted to display a separate “reply” GUI object associated with each separate defined display region.

25. A messaging system comprising:
an electronic communication network;
sender user equipment connected to the electronic communication network, comprising:
a user interface for entering message components, entering or selecting recipient addresses and associating message components and recipient addresses;
memory for storing message components, recipient addresses and their association;
a sender processor for generating a single message for each recipient including each message component associated with that recipient's address, and sending each message to its recipient;
recipient user equipment connected to the electronic communication network, comprising:
a recipient processor for receiving electronic messages including multiple message components and identifying the respective message components; and
a recipient display system for displaying the respective message components in separate defined recipient display regions.

26. A messaging system as claimed in claim 25, wherein the sender processor is adapted to insert one or more tags when generating a message, the tag(s) defining a message component.

27. A messaging system as claimed in claim 25, wherein the user interface includes a sender display system for displaying each message component in a separate defined sender display region.

28. A messaging system as claimed in claim 27, wherein each separate defined sender display region is a separate pane within a single window.

29. A message composing apparatus as claimed in claim 27, wherein the sender display system is adapted to display a separate address field for display and entry of recipient addresses for each separate defined sender display region.

30. A messaging system as claimed in claim 25, wherein the sender processor is adapted to send messages to a plurality of recipients in response to a single send command, at least one of the messages including a plurality of message components.

31. A messaging system as claimed in claim 25, wherein each separate defined recipient display region is a separate pane within a single window.

32. A messaging system as claimed in claim 26, the recipient processor being adapted to identify one or more tags within a received electronic message, the tags defining one or more message components.

33. A messaging system as claimed in claim 25, the recipient display system being adapted to display a separate “reply” GUI object associated with each separate defined recipient display region.

34. An email message generated and sent by the method of claim 1.

35. An email message including a first message component for receipt by each member of a first list of recipients and a second message component for receipt by each member of a second list of recipients.

36. An email message as claimed in claim 35, including one or more tags defining the second message component.

37. An email message as claimed in claim 35, for receipt by a recipient who is a member of both the first list of recipients and the second list of recipients.

38. An email message as claimed in claim 35, wherein at least one recipient is a member of only one of the first and second lists.

39. An email message as claimed in claim 35, wherein the second list is a subset of the first list.
